(19) United States
(12) Patent Application Publication
(10) Pub. No.: US 2013/0219963 A1
(43) Pub. Date: Aug. 29, 2013

(54) METHOD FOR PRODUCING SYNTHETIC QUARTZ GLASS GRANULES

(71) Applicants: Walter Lehmann, Leipzig (DE); Thomas Kayser, Leipzig (DE)

(72) Inventors: Walter Lehmann, Leipzig (DE); Thomas Kayser, Leipzig (DE)

(73) Assignee: Heraeus Quarzglas GmbH & Co. KG, Hanau (DE)

(21) Appl. No.: 13/882,136

(22) PCT Filed: Oct. 28, 2011
(86) PCT No.: PCT/EP2011/069068

§ 371 Date: Apr. 30, 2013

(30) Foreign Application Priority Data
Oct. 28, 2010 (DE) 102010049676.6

(51) Int. Cl. C03B 20/00; C03C 12/00

(52) U.S. Cl. CPC C03B 20/00; C03C 12/00
USPC 65/17.4; 65/21.1

(57) ABSTRACT

The production of synthetic quartz glass granules by vitrifying a free-flowing SiO₂ granulate from porous granulate particles is time-consuming and expensive. The aim of the invention is to provide a method that allows a continuous and cost-effective production of dense synthetic quartz glass granules on the basis of porous SiO₂ granulate. According to the invention, this is achieved by the following method steps: (a) granulating pyrogenically produced silicic acid with the formation of the SiO₂ granulate made of porous granulate particles; (b) drying the SiO₂ granulate; (c) cleaning the SiO₂ granulate by heating in an atmosphere containing halogen in a cleaning furnace; and (d) vitrifying the cleaned SiO₂ granulate by sintering in a vitrifying furnace with the formation of quartz glass granules. The drying, cleaning, and vitrifying of the SiO₂ granulate are each carried out in a tary tube of a rotary tube furnace, said rotary tube rotating about a central axis. The rotary tube furnace used for vitrifying has a rotary tube, the inner wall of which consists of a ceramic material with a higher softening temperature than undoped quartz glass. Said rotary tube is flooded with a low-nitrogen treating gas or flushed with the treating gas, said gas containing at least 30 vol. % helium and/or hydrogen.

The present invention refers to a method for producing synthetic quartz glass granules by vitrifying a free-flowing SiO₂ granulate from porous granulate particles.

The dense quartz glass granules can be used for producing quartz glass components, such as crucibles, tubes, holders, bells, reactors for semiconductor or lamp manufacture and for chemical process engineering. Apart from a high purity and a high chemical resistance, a high temperature stability often plays a decisive role in such manufacturing processes. Temperature values around 1150% are indicated in the literature as the lower softening point for pure quartz glass. The necessary process temperatures are however often higher, resulting in plastic deformations of the quartz-glass components.

### PRIOR ART

The basic problem consists in densifying the porous SiO₄ granulate without any bubbles, if possible. The porous granulate particles are agglomerates of SiO₂ particles, as are e.g, obtained in the manufacture of synthetic quartz glass by polymerization, polycondensation, precipitation or CVD methods. On account of their low bulk density, the direct fusion of such SiO₂ particles poses problems, and these are normally pre-densified with the help of standard granulation methods. Roll granulation, spray granulation, centrifugal atomization, fluidized bed granulation, granulating methods using a granulating mill, compaction, roller presses, briquetting, flake production or extrusion should be mentioned as examples.

The discrete, mechanically and possibly also thermally pre-densified particles obtained thereby are thus composed of a multitude of primary particles and are here called “SiO₂ granulate particles”. In their entirety they form the porous “SiO₂ granulate”.

During fusion of the “SiO₂ granulate” into quartz glass there is the risk that closed, gas-filled cavities are formed which cannot be removed or can be removed only at a very slow pace from the highly viscous quartz glass mass and which thereby lead to bubbles in the quartz glass, Therefore, it is normally necessary for sophisticated applications that dense vitrified quartz-glass particles should be produced from the porous granulate particles.

EP 1 076 043 suggests that porous SiO₂ granulate should be poured into a burner flame to finely disperse the same and to vitrify it at temperatures of 2000-2500° C. The granulate is preferably obtained by spray or wet granulation of filter dust and has grain sizes in the range of 5 μm to 300 μm. Prior to vitrification it can be heated by treatment with microwave radiation and can be pre-densified.

The degree of sintering of a given granulate particle depends on its particle size and on the heat input which, in turn, is determined by the residence time in the burner flame and the flame temperature. As a rule, however, the granulate shows a certain particle size distribution, and the combustion gas flame has regions of different flow velocities and flame temperatures. This leads to irregular and hardly reproducible sintering degrees. Moreover, there is the risk that the quartz glass particles are contaminated by the combustion gases. Loading with hydroxyl groups upon use of hydrogen-containing combustion gases should here particularly be mentioned, which is accompanied by a comparatively low viscosity of the quartz glass.

EP 1 088 789 A2 suggests for the vitrification of porous SiO₂ granulate that the synthetically produced granulate should first be cleaned by heating in HCl-containing atmosphere in a rotary furnace and that it should subsequently be calcined in a fluidized bed and then vitrified in a vertical fluidized-bed apparatus or in a crucible under vacuum or helium or hydrogen to obtain synthetic quartz-glass granules.

This represents a discontinuous vitrification process accompanied by great thermal inertia of the furnace and thus long process periods with correspondingly great efforts in terms of time and costs and with a low throughput and with a granulate that is relatively expensive on the whole.

In a similar method according to JP 10287416A, particulate SiO₂ gel with diameters in the range between 10 μm and 1,000 μm is continuously densified in a rotary furnace. This furnace comprises a rotary tube of quartz glass having a length of 2 m and an inner diameter of 200 mm. The rotary tube is heated by means of heaters from the outside and divided into plural temperature zones that cover the temperature range of 50° C. to 1,100° C. The particulate SiO₂ gel with particles sizes between 100 μm and 500 μm is freed of organic constituents in the rotary tube, which is rotating at 8 rpm, by supply of an oxygen-containing gas and is sintered to form SiO₂ powder. The furnace atmosphere during sintering contains oxygen and, optionally, argon, nitrogen or helium.

The SiO₂ powder obtained thereafter contains, however, also silanol groups in a high concentration of not less than 1,000 wt. ppm. For the elimination thereof the SiO₂ powder is subsequently calcined and dense-sintered at an elevated temperature of 1,300° C. in a quartz glass crucible with an inner diameter of 550 15 mm in batches of 130 kg.

The thermal stability of a rotary tube of quartz glass is insufficient for this process. In the quartz glass crucible, however, there may occur a caking of the sintering granulate particles, resulting in an undefined pore-containing quartz glass mass.

WO 88/03914 A1 also teaches the reduction of the BET surface area of an amorphous porous SiO₂ powder using a rotary furnace in a helium- and/or hydrogen-containing atmosphere. In a first procedure fine SiO₂ soot dust is put into a rotary furnace, heated in air to 1200° C. and kept at this temperature for 1 h. As a result of this process, a free-flowing, spherical granulate with grain sizes of 0.1 mm to 5 mm and a BET surface area of <1 m²/g is mentioned. Soot dust is however not free-flowing, it is extremely sinter-active, and it can be easily blown away. The processing of soot dust in a rotary furnace is therefore extremely difficult. In a modification of this procedure, it is suggested that SiO₂ soot dust should be mixed with water, resulting in a moist crumb-like mass. This mass is put into a rotary furnace and densified at a temperature of 600° C. into a powder having grain sizes of 0.1 mm to 3 mm. The SiO₂ powder that has been pre-densified in this way is subsequently vitrified in a separate furnace.

DE 10 2004 038 602 B3 discloses a method for producing electrically melted synthetic quartz glass for use in the manufacture of lamps and semiconductors. Thermally densified SiO₂ granulate is used as the starting material for the electrically melted quartz glass. The granulate is formed by granulating an aqueous suspension consisting of amorphous, nanoscale and pyrogenic SiO₂ particles produced by flame hydrolysis of SiCl₄.

For increasing the viscosity the SiO₂ granulate is doped with Al₂O₃ by adding nanoparticles of pyrogenically produced Al₂O₃ or a soluble aluminum salt to the suspension.

This yields round granulate grains having outer diameters in the range between 160 μm and 1000 μm, which are dried at about 400° C. in the rotary furnace and densified at a temperature of about 1420° C. up to a BET surface area of about 3

For complete vitrification the individual grains of the granulate are then completely vitrified in different atmospheres, such as helium, hydrogen or vacuum, but otherwise in processes that are not explained. The heating profile during vitrification of the granulates comprises heating to 1400° C. at a heating rate of 5° C./min and a holding time of 120 min. After this treatment the individual granulate grains are vitrified in themselves. The grains are present in individual form without being melted into a mass.

The granulate is further processed in an electric melting process to obtain quartz glass; it is e.g. melted in a crucible to obtain a molding or it is continuously drawn into a strand in a crucible type drawing method.

This also constitutes a discontinuous method with a plurality of cost-intensive heating processes.

U.S. Pat. No. 4,255,332 A describes the use of a rotary furnace for producing glass particles for filtering purposes. Finely ground glass powder with particle sizes of around 100 μm is mixed with water and binder and processed into granulate particles with particle sizes of about 300 μm-4.5 mm. These particles are sintered in a rotary furnace having a rotary tube of mullite into substantially spherical pellets with sizes of around 500-4000 μm.

### TECHNICAL OBIECT

It is the object of the present invention to indicate a method that starting from porous SiO₂ granulate permits a continuous and inexpensive production of dense synthetic quartz-glass granules.

### GENERAL DESCRIPTION OF THE INVENTION

Starting from a method of the aforementioned type, this object is achieved according to the invention by a method comprising the following method steps:
(a) granulating pyrogenically produced silicic acid with formation of the SiO₂ granulate made of porous granulate particles;
(b) drying the SiO₂ granulate;
(c) cleaning the SiO₂ granulate by heating in an atmosphere containing halogen in a cleaning furnace;
(d) vitrifying the cleaned SiO₂ granulate by sintering in a vitrifying furnace with formation of the quartz glass granules,
   wherein drying, cleaning and vitrifying of the SiO₂ granulate are each carried out in a rotary tube of a rotary furnace, said rotary tube rotating about a central axis, wherein the rotary furnace used for vitrifying has a rotary tube which consists at least over a sub-length of its inner wall of Et ceramic material with a higher softening temperature than undoped quartz glass, and wherein the rotary tube is flooded with a low-nitrogen treatment gas or flushed with the treatment gas, said gas containing at least 30 vol. % helium and/or hydrogen.

The SiO₂ granulate is obtained in that pyrogenically produced silicic acid—hereinafter also called “'SiO₂ soot dust”—is pre-densified with the help of standard granulation methods. The granulating process can be performed by using a rotary tube, as is known from the prior art. It is however essential that the thermal treatment steps subsequent to the granulate manufacturing process, namely drying, cleaning and vitrifying, are each carried out in a rotary furnace. This achieves a substantially continuous production process, and a change of the furnace system is avoided. This facilitates timing as well as spatial adaptation in successive treatment steps and helps to shorten the cycle time of the granulate.

The rotary furnaces are tailored to the specific requirements of the respective treatment step. A rotary furnace may here be subdivided into a plurality of treatment chambers kept separated from one another. To be more specific, in the case of a granulate that is already substantially dry, finish drying as well as cleaning can be carried out in a method step in a cleaning furnace. Ideally, however, a separate rotary furnace is provided for each of the treatment steps drying, cleaning and vitrifying. Treatment duration, temperature and atmosphere can thereby be optimally adapted to the respective process independently of each other, which results in a qualitatively better end product. As a result, e.g. during the transitions from drying to cleaning and from cleaning to vitrifying it is e.g. possible to utilize the residual heat of the preceding process.

The treatments are each carried out in rotary furnaces with a heated rotary tube rotating about a central axis. This tube is slightly inclined in the longitudinal direction of the furnace to induce a transportation of the granulate from its inlet side to the outlet side.

On account of the high temperature and the material load entailed thereby, this leads to special requirements during vitrification in the rotary furnace; these shall be explained in more detail hereinafter.

Viewed over the length of the rotary tube a temperature profile is produced during vitrification with a temperature maximum that is higher than the softening temperature of quartz glass, i.e. above 1150° C. To allow this without deformation of the rotary tube, the inner wall of the rotary tube or at least the highly loaded part thereof consists of a temperature-resistant ceramic material having a higher softening temperature than undoped quartz glass.

The rotary tube consists of one part or of a plurality of parts, the inner wall of the rotary tube consisting of the temperature-resistant ceramic material at least over the sub-length that is exposed to the maximum temperature load. The inner wall is an integral part of the rotary tube or it is e.g, configured as an inner lining of the rotary tube.

The granulate particles are heated in the rotary tube to a temperature that is sufficient for vitrification. The quartz glass particles obtained therefrom after vitrification have a specific surface area of less than 1 cm²/g (determined according to DIN ISO 9277—May 2003. “Bestimmung der spezifischen Oberflāche von Feststoffen durch Gasadsorption nach dem BET-Verfahren”. The surface is dense; the particles may here be transparent or partly opaque.

To enable the vitrification of the bulk material consisting of porous SiO₂ granulate in the rotary tube, another precondition is an atmosphere containing helium and/or hydrogen. A fusion of the porous granulate particles without bubbles or specifically almost without bubbles can only be achieved in an atmosphere containing helium and/or hydrogen. Possibly entrapped gases consist mainly (e.g. at least 90 vol. %) of helium, Amounts of hydrogen which can also easily diffuse out during further processing of the vitrified quartz glass granules are harmless and also small amounts of other gases.

It is therefore intended according to the invention that during vitrification the rotary tube is either flooded with a treatment gas or that it is flushed with this treatment gas continuously or from time to time, wherein the treatment gas consists of at least 30 vol. % of helium and/or hydrogen and at the same time contains hardly any, or ideally no, nitrogen, for it has been found that granulate particles vitrified in the presence of nitrogen tend to have a higher bubble content.

When traveling through the rotary tube, the granulate particles are exposed to mechanical forces which are produced by the weight and the circulation of the bulk material. Possible agglomerates of the vitrified granules are here dissolved again.

Vitrification in the rotary furnace comprises one pass or plural passes. In the case of plural passes the temperature can be raised from pass to pass. It has been found that in the case of plural passes lower bubble content is achieved in the quartz glass granules.

Drying of the granulate according to method step (b) is preferably carried out by heating in air at a temperature ranging from 200° C. to 600° C.

In this procedure, a separate drying furnace which is configured as a rotary furnace is provided for drying the granulate. The temperature is constant or is raised with the progress of the drying process. At temperatures below 200° C. one obtains long drying periods. Above 600° C. a rapid exit of entrapped gases, which may lead to a destruction of the granulates, may occur.

Cleaning in the rotary tube according to method step (c) is carried out in a chlorine-containing atmosphere at a temperature ranging between 900 and 1250° C.

The chlorine-containing atmosphere especially effects a reduction of alkali and iron impurities from the SiO₂ granulate. Temperatures below 900° C. lead to long treatment durations and temperatures above 1250° C. pose the risk of a dense-sintering of the porous granulate with inclusion of chlorine or gaseous chlorine compounds.

Unless otherwise indicated, the following explanations refer to advantageous configurations during vitrification of the granulate in the rotary furnace.

With respect to a particularly high density and a low bubble content, a treatment gas has turned out to be useful during vitrification that contains at least 50 vol. % helium and/or hydrogen, preferably at least 95 vol. %. The residual amount may be formed by inert gases, such as argon or by nitrogen and/or oxygen, the volume fraction of the two last-mentioned gases being preferably less than 30%.

The granulate particles are heated in the rotary furnace to a temperature that effects vitrification. A temperature in the range of 1300° C. to 1600° C. has turned out to be useful.

At temperatures of less than 1300° C. a long treatment period is required for complete vitrification. Preferably, the temperature is at least 1450° C. At temperatures above 1600° C. rotary tube and furnace are thermally excessively loaded.

The mechanical load on the granulate due to rotation of the rotary tube reduces the risk of agglomerate formations. At high temperatures above about 1400° C. the quartz glass is however partly softened, so that adhesions to the rotary tube wall may be observed in the areas showing hardly any movement.

To avoid such a situation, it is intended in a preferred procedure that the granulate particles are subjected to vibration.

Vibration can be produced by shaking or striking or by ultrasound. It is carried out regularly or in pulsed fashion from time to firm The high vitrification temperature can be produced by burners acting on the granulate particles. Preferred is however a procedure in which heating is carried out by means of a resistance heater surrounding the rotary tube.

The heat input via the rotary tube requires a configuration consisting of a temperature-resistant ceramic material, as has been explained above. This prevents a situation where the granulate particles are exposed to a combustion gas mechanically (by blowing away) or chemically (by impurities).

A substance that simultaneously increases the viscosity of quartz glass. preferably Al₂O₃, ZrO₂ or Si₃N₄, is advantageously suited as a material for the inner wall of the rotary tube.

In this case the material of the inner wall of the rotary tube exhibits the additional characteristic that it contains a dopant that contributes to an increase in the viscosity of quartz glass and thus to an improvement of the thermal stability of quartz glass components. The porous granulate particles that do not contain the dopant or contain it in an inadequate concentration are continuously heated in the rotary tube and thereby circulated. Contact with the dopant-containing inner wall yields a finely divided abrasion which leads to a desired doping of the granulate particles or contributes thereto. As a rule, the dopant is present in the quartz glass as an oxide. Hence, a central idea of this embodiment of the method according to the invention consists in carrying out the complete vitrification of the porous SiO₂ granulate particles in a rotary furnace at a high temperature, which is made possible by way of a suitable atmosphere during vitrification and by a temperature-resistant material for the rotary tube, which simultaneously serves due to abrasion as a dopant source for the quartz glass granules. This method permits a continuous vitrification of the SiO₂ granulate particles and thus homogeneous loading with the viscosity-enhancing dopant at the same time. Especially Al₂O₃ and nitrogen (in the form of Si₃N₄) are suited as suitable dopants in this sense. For an adequate input of said dopants it is advantageous when the inner wall of the rotary tube consists at least in the highly loaded area of the substance in question of at least 90% by wt., preferably at least 99% by wt.

Al₂O₃, in particular, is distinguished by a high temperature resistance, a high thermal shock resistance and corrosion resistance. In the simplest case the whole inner wall of the rotary tube consists of Al₂O₃. Otherwise, the part of the rotary tube that is exposed to the highest temperature load consists of Al₂O₃.

At high temperatures the granulate particles and the vitrified quartz-glass particles may be contaminated by abrasion of the material of the inner wall of the rotary tube. Already minor alkali contents enhance the tendency of quartz glass to devitrification considerably. Therefore, the substance of the inner wall of the rotary tube preferably comprises an alkali content of less than 0.5%.

For doping the quartz glass particles with Al₂O₃ this contamination is counteracted by way of impurities if the inner wall of the rotary tube consists of synthetically produced Al₂O₃.

Synthetically produced Al₂O₃ with a purity of more than 99% by wt. is known under the trade name “Alsint”. To minimize the costs of the material, the synthetic material can be limited to the area of a thin inner lining of the rotary tube.

When an Al₂O₃-containing rotary tube is used, the quartz glass granules can thereby be Al₂O₃-doped in the range of from 1 to 20 wt. ppm in a simple manner.

As an alternative, the inner wall of the rotary tube consists of ZrO₂ or TiO₂.

These materials are distinguished by sufficiently high melting temperatures for the vitrification of the SiO₂ granulate (ZrO₂: about 2700° C.; TiO₂: about 1855° C.) and they are harmless as contamination in a small concentration for many applications, e.g. for semiconductor manufacturing.

Apart from a possible metallic surrounding, the rotary tube consists entirely of the ceramic material in the simplest case.

The method according to the invention yields particularly good results when'the granulate particles have a mean grain size between 100 μm and 2000 μm, preferably between 200 μm and 400 μm.

Granulate particles with a grain size of more than 1000 μm can only be vitrified at a slow pace. Particles with a mean grain size of less than 20 μm tend to agglomerate.

For a vitrification of the granulate particles that is as uniform as possible and for a loading with dopant that is as homogeneous as possible, approximately identical particle sizes are advantageous. In this respect it has turned out to be useful when the granulate particles have a narrow particle size distribution in which the particle diameter assigned to the D-₉₀ value is at the most twice as large as the particle diameter assigned to the D₁₀ value.

A narrow particle size distribution exhibits a comparatively low bulk density, which counteracts agglomeration during vitrification. Moreover, in the case of an ideally monomodal size distribution of the granulate particles, the weight difference between the particles is no longer applied as a parameter for a possible separation in the bulk material, which is conducive to a more uniform vitrification of the bulk material.

The vitrified quartz glass particles can be used for producing components of opaque or transparent quartz glass, as e.g. a tube of opaque quartz glass which is produced in a centrifugal process. They can also be used as a particulate start material for producing a quartz glass cylinder in the so-called Verneuil process.

Preferably, the quartz glass particles are however used for producing a quartz glass crucible, particularly for producing the outer layer of the crucible.

The viscosity-enhancing effect of the dopant of the quartz glass particles helps to prolong the service life of the quartz glass crucible.

### EMBODIMENT

The invention will now be explained in more detail with reference to an embodiment and a drawing. Shown is diagrammatically in

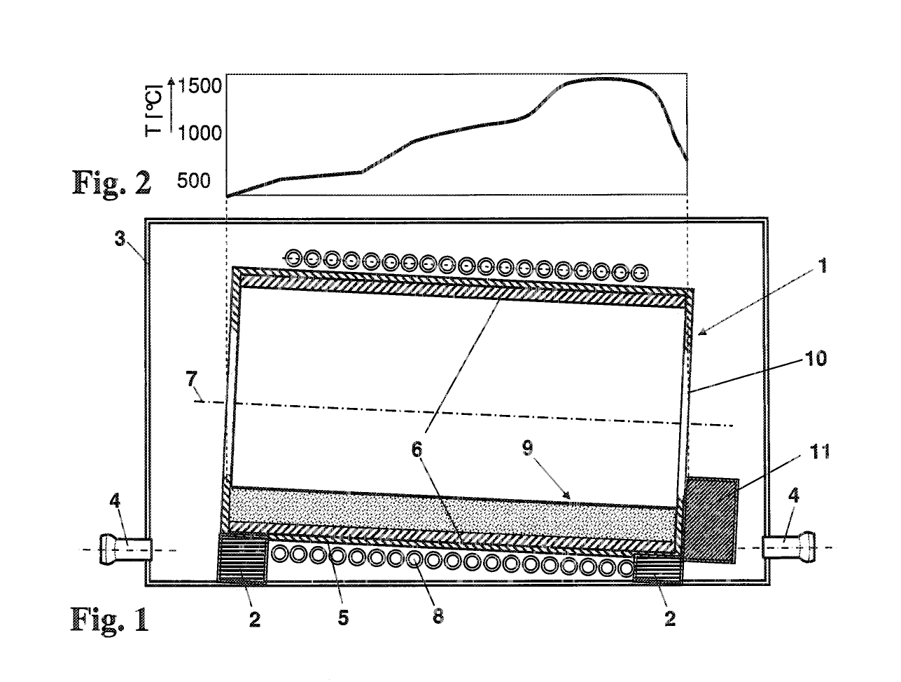

FIG. 1 a rotary furnace for performing the vitrification step in the method according to the invention, in a side view: and

FIG. 2 a temperature profile over the length of the rotary furnace.

FIG. 1 shows a rotary furnace 1 which is supported on rollers 2 and arranged within a closed chamber 3 which can be evacuated via a gas connection 4 and which can be flooded and flushed with a treatment gas.

The rotary furnace 1 substantially comprises a frame 5 of SiC in which a rotary tube 6 of synthetically produced Al₂O₃ (trade name Alsint) and with an inner diameter of 150 mm and a length of 1.8 m is fixed. The rotary tube 6 is rotatable about a central axis 7 and heatable by means of a resistance heater 8 provided on the outer jacket.

The rotary furnace 1 is slightly inclined in longitudinal direction 7 relative to the horizontal to induce the transportation of a loose material consisting of porous SiO₂ granulate 9 from the inlet side of the rotary furnace 1 to the outlet side 10. A discharge housing 11 for vitrified quartz glass granules is arranged at the outlet side 10.

An embodiment of the method according to the invention will now be described in more detail:

### Producing, Drying and Cleaning SiO₂ Granulate

### Example A

The granulate was produced by granulating a slurry with 60% by wt. of residual moisture from pyrogenic silicic acid (nanoscale SiO₂ powder, SiO₂ soot dust) and demineralized water in the intensive mixer. After granulation the residual moisture was <20%. The granulate was sieved to grain sizes of <3 mm.

The residual moisture was lowered to <1% by drying at 400° C. in a rotary furnace (throughput: 20 kg/h) in air. Sieving to the fraction 150-750 μm (D10 value about 200 μm, D90 value about 400 μm) was carried out.

Subsequently, cleaning and further drying in HCl-containing atmosphere was carried out in the rotary furnace at a maximum temperature of 1040° C. (throughput: 10 kg/h). The specific surface area (BET) is here reduced by about 50%.

This yielded a SiO₂ granulate of synthetic undoped quartz glass of high purity. It consists essentially of porous spherical particles with a particle size distribution having a D10 value of 200 μm. a D90 value of 400 μm, and a mean particle diameter (D50 value) of 300 μm.

### Example B

If The granulate was produced by high-speed granulation from pyrogenic silicic acid (nanoscale SiO₂ powder, SiO₂ dust) and demineralized water in the intensive mixer. For this purpose demineralized water is fed into the intensive mixer and pyrogenic silicic acid is added under mixing until the residual moisture is about 23% by wt. and a granulate is produced. The granulate is sieved to grain sizes of <2 mm.

The residual moisture is lowered to <1% by drying at 350° C. in a rotary furnace (throughput 15 kg/h) in air. No further sieving operation is carried out.

Subsequently, cleaning and further drying is carried out in HCl-containing atmosphere in the rotary furnace at temperatures of 1050-1150° C. (throughput: 10 kg/h).

The sum of chemical contaminants is reduced during hot chlorination to less than 1/10 of the starting material (i.e. to <10 ppm). The granulate consists essentially of porous spherical particles having a particle size distribution with a D10 value of 300 μm, a D90 value of 450 μm and a mean particle diameter (D50 value) of 350 μm.

### Vitrification of the Granulate

The rotary tube 6 which is rotating about its rotation axis 7 at a rotational speed of 8 rpm is continuously fed with undoped porous SiO₂ granulate 9 at a feed rate of 15 kg/h.

The rotary tube 6 is inclined in longitudinal direction 7 at the specific angle of repose of the granulate particles 9, so that a uniform thickness of the loose granulate is set over the length thereof.

The chamber 3 is evacuated from time to time and subsequently flooded with helium. The loose granulate 6 is continuously circulated and heated in this process by means of the resistance heater 8 within the rotary tube 6 and gradually vitrified in this process. The maximum temperature is achieved shortly before the discharge end 10. The rotary tube 6 of Al₂O₃ withstands said temperature without difficulty.

A typical axial temperature profile over the length of the rotary tube 6 is schematically illustrated in the diagram of FIG. 2. The temperature T of the surface of the loose granulate 9 (determined by means of pyrometer) is plotted on the y-axis against the axial position in the rotary tube 6. Directly after having been supplied, the granulate is dried at a temperature of about 500° C. for a duration of 30 min, and it is subsequently pre-densified thermally at a gradually rising temperature at about 100° C. to 1300° C. The gas contained in the porous granulate is here replaced by helium at the same time. The densification and gas-exchange process lasts for about 60 min. Subsequently, the loose granulate 9 is heated up for complete vitrification, thereby reaching a maximum temperature of about 1460° C. The mean residence time in the rotary furnace 6 is about 3 h. After subsequent cooling the vitrified granulate is removed from the rotary furnace 9.

The above-mentioned process parameters in combination with the residence time of the granulate 9 in the rotary furnace 1 and the helium atmosphere have the effect that the open porosity is mainly disappearing. The surface is dense. If agglomerates are formed, these are dissolved again due to the mechanical stress in the moving loose granulate material or by the vibration of the rotary tube.

At the same time the granulate particles 9 which get into contact with the wall of the rotary tube 6 produce a uniform abrasion of Al₂O₃, which passes onto the surface of the granulate particles 9 and into the pores thereof. The vitrified quartz glass granules produced thereby are homogeneously doped with Al₂O₃ at about 15 wt. ppm. Adhesions to the inner wall of the rotary tube 6 are mainly avoided because of the poor wettability of Al₂O₃ with quartz glass.

The completely vitrified and homogeneously doped quartz glass granules have a density of more than 2.0 g/cm³ and a BET surface area of less than 1 m²/g. They are continuously removed by means of the discharging device 11.

The quartz glass granules are used for producing the outer layer of a quartz glass crucible, with the viscosity-enhancing effect of the Al₂O₃ doping assisting in increasing the service life of the quartz glass crucible.

Further embodiments illustrating the vitrification of porous SiO₂ granulate in the rotary furnace in He atmosphere according to the invention shall now be explained hereinafter:

### EXAMPLE 1

### Using the Granulate of Example A

In a preliminary test, the granulate was sintered in ambient atmosphere (air) at a maximum temperature of 1350°. At temperatures of >1350° C. the material adheres to the rotary tube. The granulate shows sinter phenomena, but many particles are not completely sintered.

In a first modification of this procedure, the granulate was sintered in He atmosphere during flushing operation at a flow rate of 1.1 m³/h and at a maximum temperature of 1350° C.

The quartz glass granules produced in this way are homogeneously sintered in part; only a few particles are not sintered. They could be vitrified in a transparent form and with hardly any bubbles in the arc melt during manufacture of quartz glass crucibles.

In a second modification of this procedure, the granulate was also sintered in He atmosphere during flushing operation at a flow rate of 2.1 m³/h and at a maximum temperature of 1400° C. Here, the material tends to adhere to the rotary tube. Adhesions could be avoided by way of mechanical vibrations (beating and shaking) of the rotary tube. This, however, resulted in a higher throughput (of 2 kg/h to 4 kg) which deteriorated the sintering degree. The throughput could be reduced again by changing the inclination. The granulate is homogeneously sintered in part; only a few particles are not sintered.

The quartz glass granules produced in this way are homogeneously sintered (only a few particles are hardly sintered or not sintered at all). They could be vitrified in a transparent form and with hardly any bubbles in the arc melt during manufacture of quartz glass crucibles.

### EXAMPLE 2

### Using the Granulate of Example B

The granulate is sintered in He atmosphere during the flushing operation at a flow rate of 3.5 m³/h and at a maximum temperature of 1400° C. The granulate shows sinter phenomena, but large particles are not completely sintered. At the given particle sizes and temperatures, the throughput of 4 kg/h is evidently too high. The material cannot be vitrified without bubbles in the arc melt; opaque portions with fine bubbles can be detected.

In a modification of the method the throughput was reduced by reducing the speed and inclination to 2.4 kg/h, and the granulate was sintered in He atmosphere during the flushing operation at a flow rate of 3.5 m³/h and at 1400° C. The quartz glass granules produced thereby are not homogeneously sintered yet. It is only when the maximum temperature is raised to 1430° C. (under otherwise identical parameters) that almost transparent quartz glass granules are obtained. At even higher temperatures, the granulate tends to adhere more and more to the rotary tube.

The quartz glass granules produced thereby could be vitrified in the arc melt during manufacture of quartz glass crucibles into transparent layers with hardly any bubbles.

In a further modification of the method, the granulate was sintered twice in successive order in He atmosphere at a flow rate of 3.5 m³/h. The first pass took place at 1400° C. and the second pass at 1450° C. Hardly any adhesions were here observed.

The quartz glass granules obtained thereby are fully vitrified in transparent form. It is only with large particles that bubble-shaped gas inclusions can be detected. They can be vitrified during manufacture of quartz glass crucibles into transparent layers containing almost no bubbles.

1. A method for producing synthetic quartz glass granules by vitrifying a tree flowing SiO₂ ganulate, said method comprising:
(a) granulating pyrogenically-produced silicic acid so as to form the SiO, granulate made of porous granulate particles;
(b) drying the SiO₂ granulate;
(c) cleaning the SiO₂ granulate by heating in an atmosphere containing at least one halogen in a cleaning furnace;
(d) vitrifying the cleaned SiO₂ granulate by sintering said SiO₂ granulate in a vitrifying furnace so as to form the quartz glass granules,
wherein said drying, said cleaning and said vitrifying of the SiO₂ granulate are each carried out in a rotary tube of a rotary furnace, said rotary tube rotating about a central axis, said rotary tube comprising, at least over a sub-length of an inner wall thereof, a ceramic material with a softening temperature that is higher than a softening temperature of undoped quartz glass,
and wherein the rotary tube is flooded with a low-nitrogen treatment gas or flushed with the treatment gas, said gas containing at least 30 vol.% helium or hydrogen or a mixture of helium and hydrogen.

2. The method according to claim 1, wherein drying of the granulate is carried out by heating in air at a temperature in the range between 200° C. and 600° C.

3. The method according to claim 1, wherein the cleaning in the rotary tube is carried out in a chlorine-containing atmosphere at a temperature in a range from 900° C. to 1250° C.

4. The method according to claim 1 wherein the treatment gas during said vitrification contains at least 50% helium or hydrogen or a mixture thereof.

5. The method according to claim 1 wherein the granulate particles during vitrification are heated to a temperature in a range from 1300° C. to 1600° C.

6. The method according to claim 5, wherein the granulate particles are subjected to vibration.

7. The method according to claim 5, wherein the heating of the granulate particles is carried out using a resistance heater surrounding the rotary tube.

8. The method according claim 5, w herein the inner wall of the rotary tube comprises a substance that enhances viscosity of quartz glass.

9. The method according to claim 8, wherein the inner wall of the rotary tube has an alkali content of less than 0.5%.

10. The method according to claim 8, wherein the inner wall of the rotary tube comprises synthetically produced Al₂O₃.

11. The method according to claim 8, wherein the quartz glass granules are doped with Al₂O₃ in a range of 1 to 20 wt. ppm and are produced using an Al₂O₃-containing rotary tube.

12. The method according to claim 5, wherein the rotary tube is entirely of ceramics.

13. The method according to claim 1, wherein the granulate particles have a mean grain size between 20 μm and 2000 μm (D₅₀ value each time).

14. The method according to claim 1, wherein the granulate particles have a particle size distribution with D₉₀ and D₁₀ particle diameter values such that the D₉₀ particle diameter value is not more than twice as large as the D₁₀ particle diameter value.

15. A method comprising:
providing quartz glass granules produced according to claim 1; and
making a quartz glass crucible therewith.

16. The method according to claim 1, wherein the treatment gas during vitrification contains at least 95% helium or hydrogen or a mixture thereof.

17. The method according claim 5, wherein the inner wall of the rotary tube comprises a substance that enhances viscosity of quartz glass, wherein said substance is selected from the group consisting of Al₂O₃, ZrO₂and Si₃N₄.

18. The method according to claim 1, wherein the granulate particles have a mean grain size between 100 μm and 400 μm (D₅₀ value each time).
